(19) United States
(12) Patent Application Publication
(10) Pub. No.: US 2009/0222497 A1
(43) Pub. Date: Sep. 3, 2009

(54) METHOD, SYSTEM AND APPARATUS FOR REMOTE SOFTWARE UPGRADE OF AN EMBEDDED DEVICE

(75) Inventor: DARCY JOSEPH RYAN, EDMONTON (CA)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/040,001

(22) Filed: Feb. 29, 2008

(51) Int. Cl. G06F 9/44; G06F 21/00; G06F 17/30

(52) U.S. Cl. 707/204; 717/173; 726/22; 707/E17.007

(57) ABSTRACT

A system method and apparatus for remote upgrade of the software of an embedded device supporting packet-based communication. A packet-based communication path is provided between a remote device and the embedded device. An intermediate device is placed in the packet-based communication path as a local node directly coupled to the embedded device. The intermediate device includes packet-forwarding means for carrying out normal communication between the remote device and the embedded device. The software of the embedded device is upgraded by i) transferring software upgrade data from the remote device to the intermediate device, ii) transferring the software upgrade data from the intermediate device to the embedded device and iii) carrying out an upgrade process on the embedded device that loads the software upgrade data on the embedded device.

### BACKGROUND OF THE INVENTION

1. Field of the Invention

The present invention relates broadly to upgrading the software of an embedded device. More particularly, the invention relates to the upgrading of software of an embedded device by a remote system.

2. Description of Related Art

Embedded devices employ a special-purpose computer system designed to perform a dedicated function. Unlike a general purpose computer, such as a personal computer, an embedded device performs one or a few pre-defined tasks, usually with very specific requirements, and often includes task-specific hardware and mechanical parts not usually found in a general-purpose computer. Since the system is dedicated to specific tasks, design engineers can optimize it, reducing the size and cost of the product. Embedded devices are often mass-produced, benefiting from economies of scale.

Embedded devices can be realized in sizes ranging from portable hand-held devices (such as digital watches and MP3 players) to large stationary installations (such as traffic lights, factory controllers, or system controllers). In terms of complexity, embedded devices can range from the simple (e.g., employ a single microcontroller chip) to very complex (e.g., employ multiple processors, peripherals and networks mounted inside a large chassis or enclosure).

Examples of embedded devices include avionic control systems, telecommunication devices such as switches and routers, automotive control devices such as engine controllers and antilock brake controllers, home automation devices such as thermostats, air conditioners, sprinklers, and security monitoring systems household appliances such as microwave ovens, washing machines, television sets, DVD players and recorders, medical equipment, computer peripherals such printers and fax machines, and industrial controllers for remote machine operation.

An embedded device employs software (e.g., system software and/or firmware and/or parameter data) that is stored in non-volatile memory (e.g., byte-programmable EEPROM. Flash memory, or hard drive) and used by the computer processing system of the device to carry out a set of pre defined tasks. In many applications, it is desirable that the embedded device provide for upgrade of its software by a remote system. However, the remote upgrade of the software of an embedded device is an inherently unreliable process unless the device has been specifically designed to support this operation. For embedded devices not so designed, the reliability of performing the remote software upgrade suffers due to slow communications links, mismatches in the size of the embedded system's non-volatile memory, and lack of direct user intervention to manually control the process. Due to these reliability issues, remote software upgrade for such devices is often avoided. Instead, a local operator performs the software upgrade operation typically by loading software into the embedded device from a portable computing device (e.g., laptop computer) coupled thereto.

Thus there remains a need in the art to provide methods, systems, and apparatus that provide for reliable remote software upgrade of an embedded device in a manner that is suitable for embedded devices that are not specifically designed to support such operations.

### BRIEF SUMMARY OF THE INVENTION

It is therefore an object of the invention to provide methods, systems, and apparatus for reliable remote software upgrade of an embedded device in a manner that is suitable for embedded devices that are not specifically designed to support such operations.

In accord with these objects, which will be discussed in detail below, a system method, and apparatus is provided for remote upgrade of the software of an embedded device supporting packet-based communication. A packet-based communication path is provided between a remote device and the embedded device. An intermediate device is placed in the packet-based communication path as a local node directly coupled to the embedded device. The intermediate device is located locally with respect to the embedded device. The intermediate device includes packet-forwarding means for carrying out normal communication between the remote device and the embedded device. The software of the embedded device is upgraded by i) transferring software upgrade data from the remote device to the intermediate device, ii) transferring the software upgrade data from the intermediate device to the embedded device, and iii) carrying out an upgrade process on the embedded device that loads the software upgrade data on the embedded device.

It will be appreciated that such systems, methodology, and apparatus provide for reliable software upgrade of an embedded device from a remote system and are suitable for embedded devices that are not specifically designed to support such operations.

According to one embodiment of the invention, a backup copy of the software of the embedded device that is to be overwritten is transferred from the embedded device to the intermediate device and returned back to the embedded device in the event that the software upgrade process fails. The backup copy is used as part of a restore process that loads the backup copy on the embedded device.

According to another embodiment of the invention, packet-based verification and/or file verification can be used to ensure integrity of the software transfer during the process.

Additional objects and advantages of the invention will become apparent to those skilled in the art upon reference to the detailed description taken in conjunction with the provided figures.

### BRIEF DESCRIPTION OF THE DRAWINGS

FIG. 1 is a functional block diagram of a system for remote software upgrade of an embedded device in accordance with the present invention.

FIGS. 2A(i) and 2A(ii), collectively, are a flowchart illustrating exemplary operations for carrying out a first phase of the remote software upgrade process for the embedded device of FIG. 1 in accordance with the present invention.

FIGS. 2B(i), 2B(ii), 2B(iii) and 2B(iv), collectively, are a flowchart illustrating exemplary operations for carrying out a second phase of the remote software upgrade process for the embedded device of FIG. 1 in accordance with the present invention.

FIG. 3 is a schematic illustration of a hydrocarbon producing facility that employs an electric submersible pump and an embedded device for remote control of the electric submersible pump as well as a system for remote software upgrading of the embedded device in accordance with the present invention.

### DETAILED DESCRIPTION OF THE INVENTION

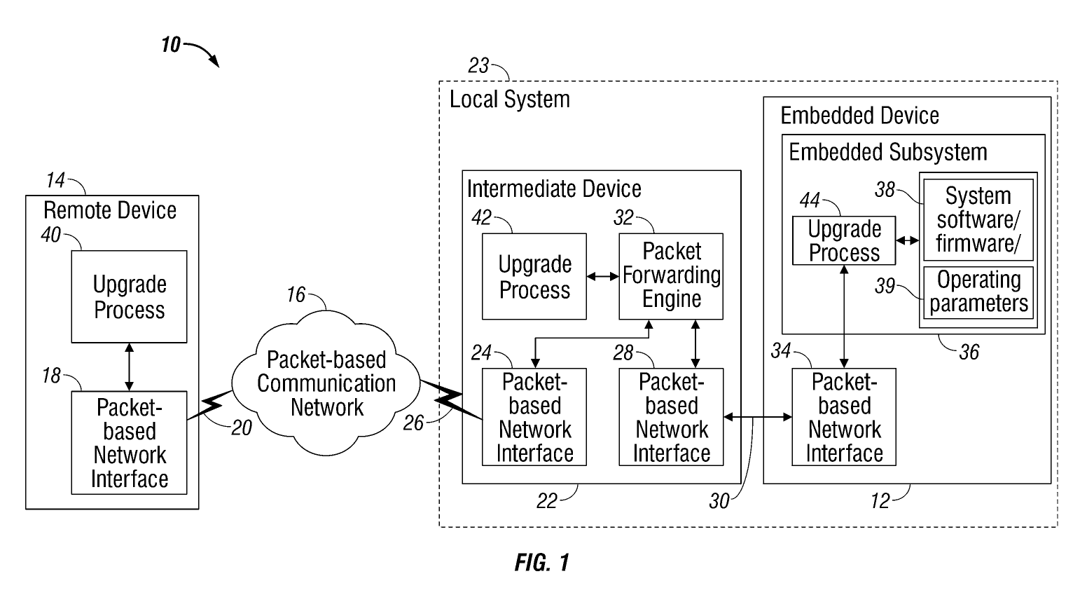

Turning now to FIG. 1, a system 10 for remotely upgrading the software of an embedded device 12 includes a remote device 14, which can be realized by a computer or server, providing a user with remote access to the embedded device 12 through a packet-based communication network 16. The remote device 14 includes a network interface 18 that interfaces to the communication network 16 over a communication link 20 therebetween. The packet-based communication network 16 provides for communication of data packets between the remote device 14 and the embedded device 12 and can be realized by a transmission control protocol/internet protocol (TCP/IP) network (including, the Internet, public access networks and proprietary networks, including wired and wireless connections) or other suitable form.

According to the present invention, an intermediate device 22 is placed in the communication path between the remote device 14 and the embedded device 12 as a local node directly coupled to the embedded device 12. In this manner, the intermediate device 22 and the embedded device 12 realize a local system 23 that is remotely located from the remote device 14 and coupled thereto by the communication network 16 as shown. It should be noted that multiple embedded devices 12 may be connected to a single intermediate device 22.

The intermediate device 22 includes a first network interface 24 that interfaces to the communication network 16 over a communication link 26 therebetween, a second network interface 28 that interfaces to the embedded device 12 over a communication link 30 therebetween, and a packet forwarding engine 32 coupled between the two network interfaces 24, 28. The first network interface 24 provides for packet-based communication with the remote device 14 over the communication network 16. The second network interface 28 provides for packet-based communication with the embedded device 12.

The embedded device 12 includes a network interface 34 that interfaces to the network interface 28 of the intermediate device 22 over the communication link 30 therebetween. An embedded subsystem 36 which is typically realized by a computer processing platform (e.g., a microprocessor non-volatile memory such as programmable ROM or flash memory, volatile memory such as DRAM, and possibly other peripherals), is coupled to the network interface 34. The embedded subsystem 36 employs software 38 (e.g., system software and/or firmware) that is stored in non-volatile memory of the embedded subsystem 36 and used to carry out a set of pre-defined tasks. The embedded subsystem 36 may optionally include operating parameters 39 that are stored in either the volatile or non-volatile memory of the embedded subsystem 36.

Outside of the remote upgrade operations of the embedded device 12 as described below in more detail, the network interfaces 24, 28, as well as the packet forwarding engine 32 of the intermediate device 22 provide packet forwarding to support normal packet-based communication between the remote device 14 and the embedded device 12. In the preferred embodiment, the remote device 14, the intermediate device 22 and the embedded device 12 are assigned different network addresses, and the packet forwarding engine 32 of the intermediate device 22 provides packet processing and routing functionality. The routing functionality routs communications packets received from the communication network 16 and destined for the embedded device 12 to the embedded device 12 over the communication link 30 provided by the network interface 28. It also routes communications packets received from the embedded device 12 and destined for network-connected devices (e.g., the remote device 14) to these devices over the communication link 26 provided by the network interface 24. The packet forwarding engine 32 can also provide for transport mode encryption or tunnel mode encryption to provide for security of the packet traffic between the remote device 14 and the embedded device 12. In the preferred embodiment of the invention the two network interfaces 24, 28 provide for packet-based communications with similar communications on communication links 26, 30. In another embodiment, the packet forwarding engine 32 provides communications translations to enable the network interfaces 24, 28 to support communications where communication links 26, 30 use different communication protocols.

The remote upgrade operations of the embedded device 12 are carried out by embedded device upgrade process blocks 40, 42, and 44 that are part of the remote device 14, the intermediate device 22, and the embedded device 12, respectively. Such remote upgrade operations are logically partitioned into two phases: a remote data transfer and verification phase (Phase 1) and a local upgrade phase (Phase 2). The Phase 1 operations transfer the software upgrade data from the remote device 14 to the intermediate device 22 and verify the software upgrade data received by the intermediate device 22. The Phase 2 operations transfer the software upgrade data from the intermediate device 22 to the embedded device 12 and carry out the software upgrade process on the embedded device 12. This software upgrade process loads the software upgrade data onto the embedded device 12 in order to upgrade the software of the embedded device 12. Optionally, as part of the Phase 2 operations, a backup copy of the software 38 and/or the operating parameters 39 of the embedded device 12 that is to be overwritten can be transferred from the embedded device 12 to the intermediate device 22 and can be returned back to the embedded device 12 in the event that the software upgrade process fails. The backup copy is used as part of a restore process that loads the backup copy oil the embedded device 12.

### Phase 1—Remote Data Transfer and Verification

The Phase 1 operations transfer the software upgrade data from the remote device 14 to the intermediate device 22 and verify the software upgrade data received by the intermediate device 22 The Phase 1 operations are carried out by the embedded device upgrade process block 40 of the remote device 14 and the embedded device upgrade process block 4A of the intermediate device 22. The Phase 1 operations can be initiated by user interaction with the remote device 14 by automatic means (e.g., a scheduled task) or other suitable means. The network interface 18 of the remote device 14 supports packet-based communication between the remote device 14 and the intermediate device 22 over the communication network 16. The network interface 24 and the packet forwarding engine 32 of the intermediate device 22 supports packet-based communication between the intermediate device 22 and the remote device 14 over the communication network 16. In the preferred embodiment, the packet forwarding engine 32 provides communications packet processing and routing functionality that routes the communications packets received from the network 16 and destined for the intermediate device 22 to the embedded device upgrade process block 42 of the intermediate device 22. It also routes packets generated by the upgrade process block 42 and destined for the remote device 14 to the communication network 16 over the communication link 26 provided by the network interface 24. The packet forwarding engine 32 can also provide for encryption, routing to and from multiple embedded devices 12, and/or communications translations between dissimilar communication links.

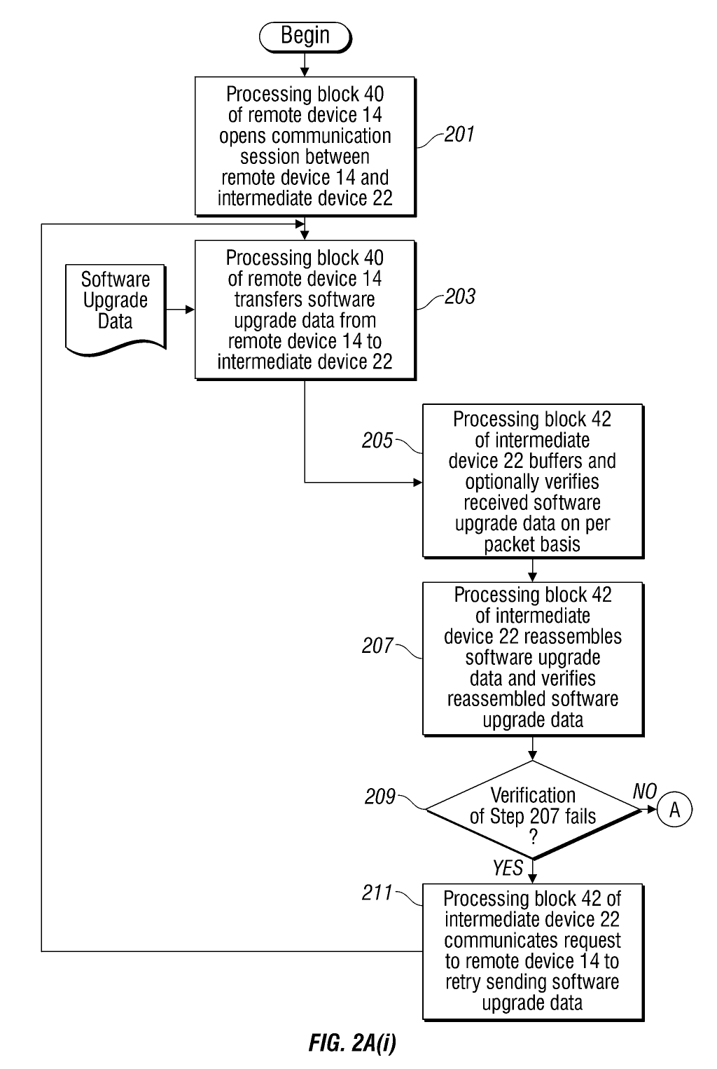

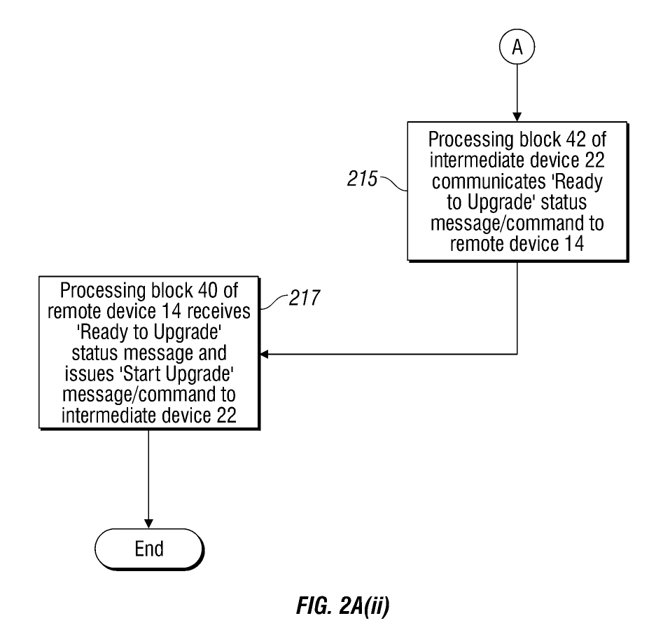

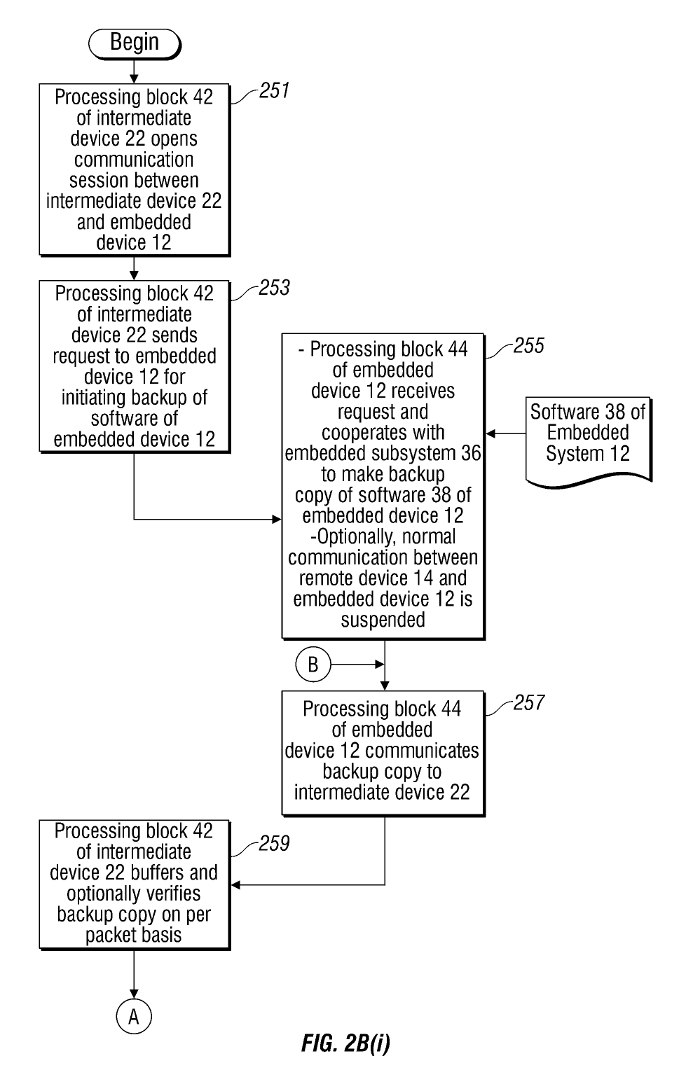

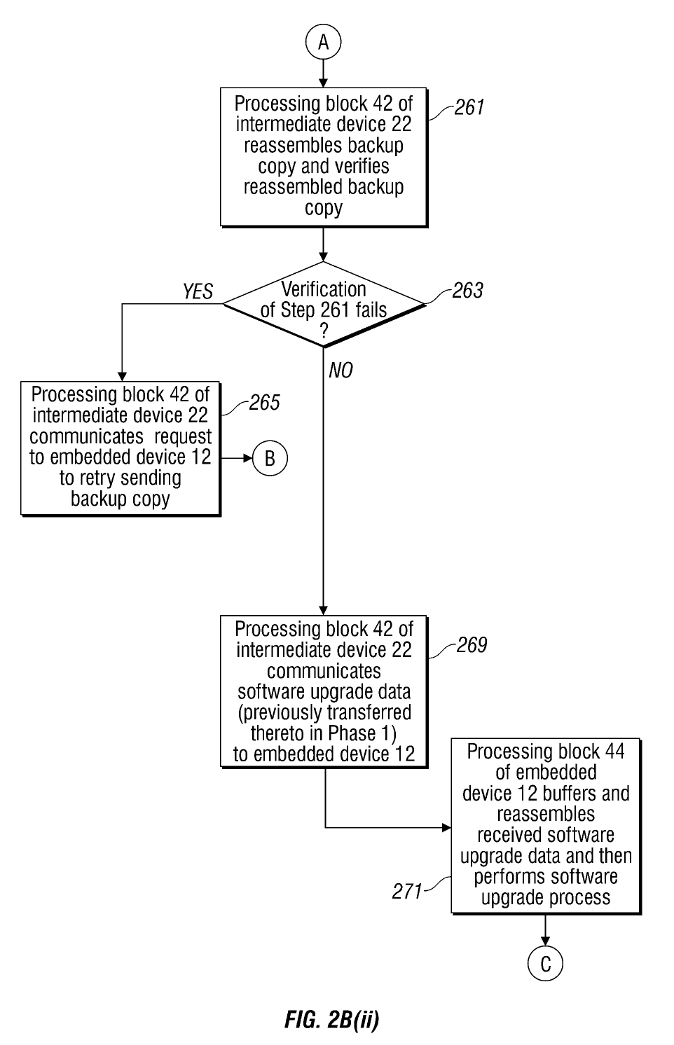

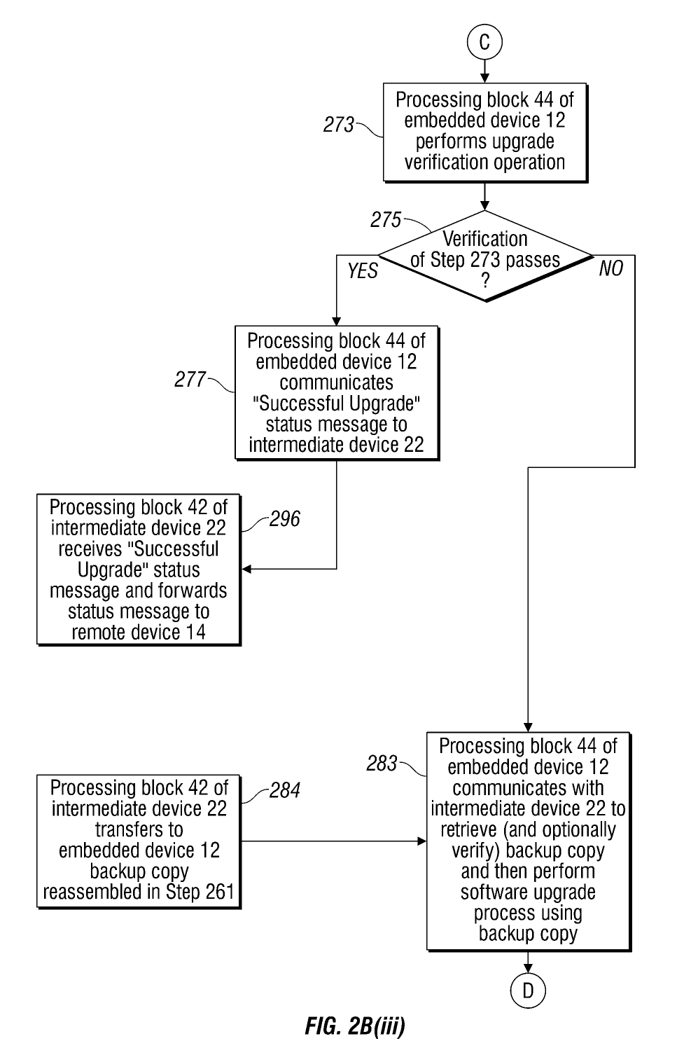

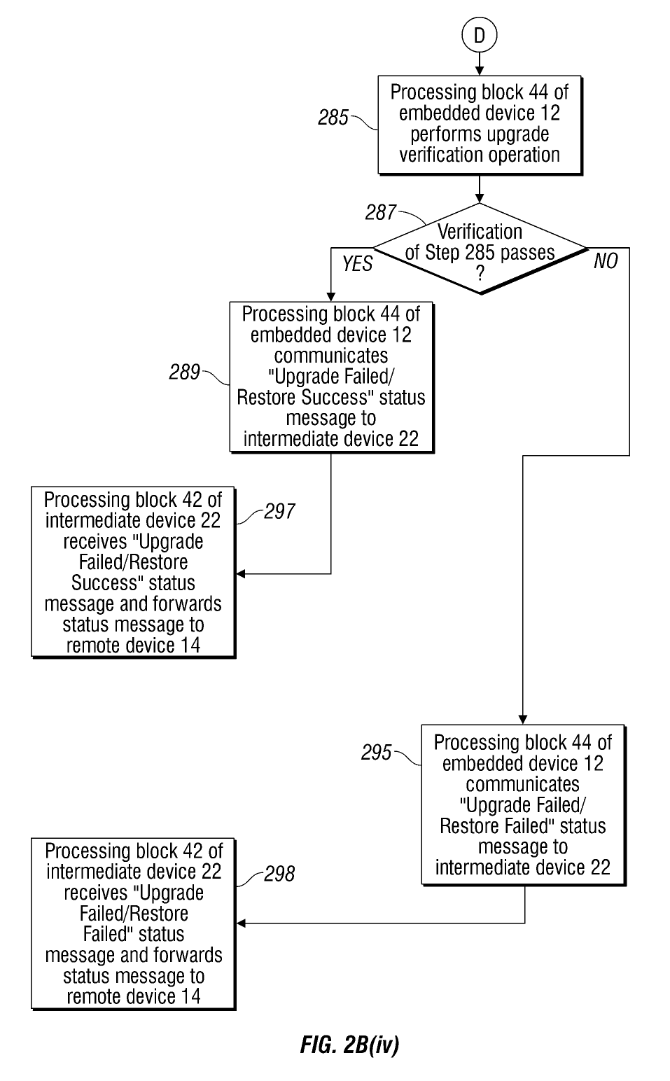

An illustrative embodiment of the Phase 1 operations is shown in the flow chart of FIGS. 2A(i) and 2A(ii). For simplicity, the operations illustrated are for an embodiment of the process for a single embedded device 12. The operations begin in step 201 by the processing block 40 of the remote device 14 opening up a communication session between the remote device 14 and the intermediate device 22. In step 203, the processing block 40 of the remote device 14 communicates software upgrade data over this communication session to transfer the software upgrade data from the remote device 14 to the intermediate device 22. Serial packet transfer, file transfer protocol (FTP), or other suitable packet data transfer techniques can be used. Such software upgrade data includes the software of the embedded device that is to be loaded onto the embedded device as part of the software upgrade process executed thereon as described below in detail.

In step 205, the processing block 42 of the intermediate device 22 buffers and optionally verifies the received software upgrade data on a per packet basis. Such packet-based verification can involve one or more of the following packet verification techniques: checksum verification, cyclical redundancy check (CRC) verification, digital signature verification, or similar techniques. The packet-based verification of the software upgrade data is recommended to improve system performance. In the event that such packet-based verification fails, the processing block 42 of the intermediate device 22 can communicate to the processing block 40 of the remote device 14 with a structured message/command that requests that the processing block 40 retry sending the specific packet that failed. This optional retry operation is not shown for simplicity of illustration.

In step 207, the processing block 42 of the intermediate device 22 reassembles the software upgrade data from the buffered packet data and verifies the integrity of the reassembled software upgrade data using checksum verification, CRC verification, digital signature verification, or similar techniques. In step 209, the processing block 42 of the intermediate device 22 determines whether the verification of step 207 fails and, if so, continues to step 211 wherein the processing block 42 of the intermediate device 22 call communicate to the processing block 40 of the remote device 14 with a structured message/command that requests that the processing block 40 retry sending the software upgrade data and the operations revert to step 203. Otherwise, the operation continues to step 215 wherein the processing block 42 of the intermediate device 22 communicates a ‘Ready to Upgrade’ status message/command to the processing block 40 of the remote device 14. In step 217, the processing block 40 of the remote device 14 receives the ‘Ready to Upgrade’ status message and issues a ‘Start Upgrade’ message/command to the intermediate device 22, which ends the Phase 1 operations.

Note that during the Phase 1 operations, normal communication between the remote device 14 and the embedded device 12 need not be impacted. This allows for such normal communication to be carried out in parallel with the transfer of the software upgrade data to the intermediate device 22.

### Phase 2—Local Upgrade

The Phase 2 operations transfer the software upgrade data from the intermediate device 22 to the embedded device 12 and carry out the software upgrade process on the embedded device 12. As part of the Phase 2 operations, a copy of any operating parameters 39 of the embedded device 12 that is to be upgraded are transferred from the embedded device 12 to the intermediate device 22 and are returned back to the embedded device 12 to restore normal operation after the upgrade process. Optionally, a backup copy of the software 38 of the embedded device 12 that is to be overwritten can be transferred from the embedded device 12 to the intermediate device 22 and can be returned back to the embedded device 12 in the event that the software upgrade process fails. The Phase 2 operations are carried out by the processing block 42 of the intermediate device 22 and the processing block 44 of the embedded device 12. The network interface 28 and the packet forwarding engine 32 of the intermediate device 22 supports communication between the intermediate device 22 and the embedded device 12 over the communication link 30. The network interface 34 of the embedded device 12 supports communication between the embedded device 12 and the intermediate device 22 over the communication link 30. In the preferred embodiment, the packet forwarding engine 32 provides packet processing and routing functionality that routes packets generated by the processing block 42 and destined for the embedded device 12 to the embedded device 12 over the communication link 30 provided by the network interface 28.

An illustrative embodiment of the Phase 2 operations is shown in the flow chart of FIGS. 2B(i) through 2B(iv). The Phase 2 operations are triggered by the processing block 42 of the intermediate device 22 receiving the ‘Start Upgrade’ message/command issued by the remote device 14 as described above. Alternatively, the Phase 2 operations can begin automatically upon successful verification of the reassembled software upgrade data in step 207 or steps thereafter. The operations begin in step 251 wherein the processing block 42 of the intermediate device 29 opens a communication session between the intermediate device 22 and the embedded device 12. In step 253, the processing block 42 of the intermediate device 22 sends a request message/command or series of messages/commands to the embedded device 12 over this communication session, the request for initiating backup of the software of the embedded device 12.

In step 255, the processing block 44 of the embedded device 12 receives this request and cooperates with the embedded subsystem 36 to make a backup copy of the operating parameters 39 and, optionally, the software 38 of the embedded device 12. Optionally, in step 255, normal communication between the remote device 14 and the embedded device 12 is suspended by the packet forwarding engine 32 if the embedded device 12 does not support communications during an upgrade process.

In step 257, the processing block 44 of the embedded device 12 communicates the backup copy to the intermediate device 22.

In step 259, the processing block 42 of the intermediate device 22 buffers and optionally verifies the backup copy on a per packet basis. Such packet-based verification can involve one or more of the following packet verification techniques: checksum verification, CRC verification, and digital signature verification. The packet-based verification of the backup copy is recommended to improve system performance. In the event that packet-based verification fails, the processing block 42 of the intermediate device 22 can communicate back to the embedded device 12 with a structured message/command that requests that the embedded device 12 retry sending the specific packet that failed. Such operations are not shown in FIG. 2B for simplicity of illustration.

In step 261, the processing block 42 of the intermediate device 22 reassembles the backup copy and verifies the integrity of the reassembled backup copy using checksum verification, CRC verification, digital signature verification, or similar techniques. In step 263, the processing block 42 of the intermediate device 22 determines whether the verification of step 261 fails and, if so, continues to step 265 wherein the processing block 42 of the intermediate device 22 communicates to the embedded device 12 with a structured message/command that requests that the embedded device 12 retry sending the backup copy. In this case, the operations of the embedded device 12 revert to step 257 to resend the backup copy and the operations of the intermediate device 22 revert to step 259 to receive the backup copy. Otherwise, the operations continue to step 269 wherein the processing block 42 of the intermediate device 22 communicates the software upgrade data (previously transferred thereto in Phase 1) to the embedded device 12.

In step 271, the processing block 44 of the embedded device 12 buffers and reassembles the received software upgrade data and then performs an upgrade process that upgrades the software of the embedded subsystem 36 of the embedded device 12. This upgrade process loads the software upgrade data onto the embedded device 12 and can be accomplished in many different ways as is well known in the art. For example, the software upgrade data can be written to non-volatile memory of the embedded subsystem 36 of the embedded device 12. In another example, the software upgrade data can be written to volatile memory of the embedded subsystem 36 of the embedded device 12, and then an instruction is issued to write the software upgrade data from the volatile to the non-volatile memory of the embedded subsystem 36 of the embedded device 12. During step 271, prior to writing the software upgrade data to the non-volatile memory of the embedded device 12, the upgrade process can optionally verify the software upgrade data on a per packet basis and/or verify the reassembled software upgrade data as described above. In the event that packet-based verification fails, the processing block 44 can communicate back to the intermediate device 22 with a structured message/command that requests that the intermediate device 22 retry sending the specific packet that failed. If the verification of the reassembled software upgrade data fails, the processing block 44 can communicate back to the intermediate device 22 with a structured message/command that requests that the intermediate device 22 retry sending the software upgrade data. The verification and retry steps are not shown for simplicity of illustration.

In step 273, after the software upgrade data is written to the non-volatile memory of the embedded device 12, the processing block 44 of the embedded device 12 performs an upgrade verification operation. This verification depends on the specific processor/memory architecture of the embedded device 12 and can include such techniques as checksum verification, CRC verification, digital signature verification, block memory compares, and file comparison verification.

In step 275, the processing block 44 determines if the verification of step 273 is successful and if so continues to step 277 to communicate a “Successful Upgrade” status message to the intermediate device 22. The operating parameters 39 previously backed up in step 255 are restored at this point. If in step 275 the processing block determines that the verification of step 273 is not successful, the upgrade process of step 271 can be optionally retried (not shown for simplicity of illustration), otherwise the operations continue to steps 283 and 284 wherein the processing block 44 of the embedded device 12 communicates with the intermediate device 22 to transfer the backup copy (previously verified in step 261) to the embedded device 12. The processing block 44 of the embedded device 12 retrieves the backup copy, optionally verifies the backup copy, and then performs an upgrade process that restores the software of the embedded subsystem 36 of the embedded device 12. This upgrade process loads the backup copy data onto the embedded device 12 in a manner similar to the upgrade process of step 271 as described above, thereby restoring the original software 38 of the embedded device 12. The operating parameters 39 previously backed up in step 255 are restored at this point.

In step 285, after writing the backup copy of the software to the non-volatile memory of the embedded device 12, the processing block 44 of the embedded device 12 performs a verification operation as described above for step 273.

In step 287, the processing block 44 of the embedded device 12 determines if the verification of step 285 is successful and, if so, continues to step 289 to communicate an “Upgrade Failed/Restore Success” status message to the intermediate device 22. If in step 287 the processing block 44 determines that the verification of step 285 is not successful, the operations continue to step 295 wherein the processing block 44 of the embedded device 12 communicates an “Upgrade Failed/Restore Failed” status message to the intermediate device 22. Optional retries of the upgrade process in step 283 are not shown for clarity of illustration.

In steps 297 and 298, the status messages received by the intermediate device 22 are forwarded on to the remote device 14 to provide the user with final status of the software update operations. Upon successful upgrade or restoration of the embedded device 12, normal communication between the remote device 14 and the embedded device 12 is restored by the user or automatic system that initiated the upgrade in Phase 1.

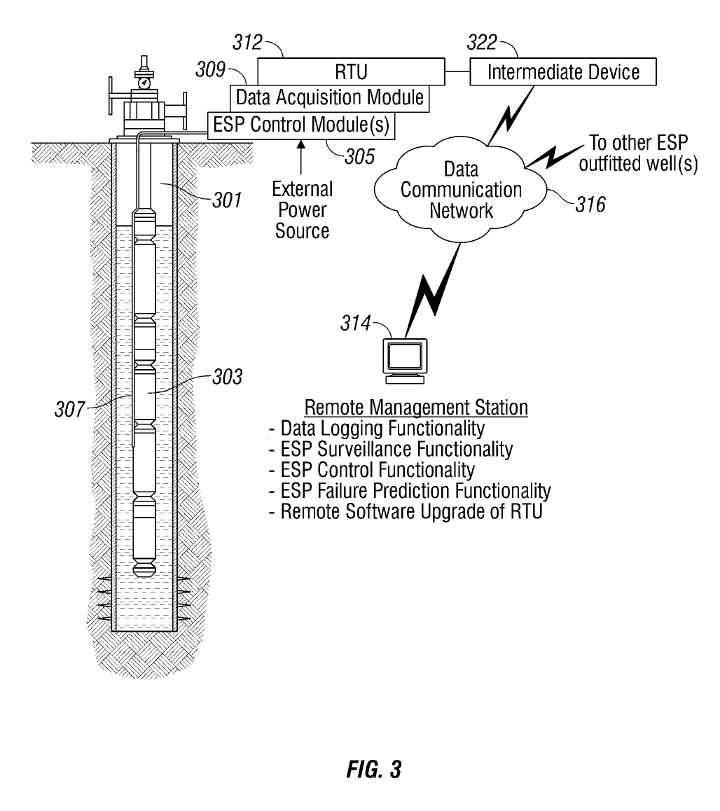

In an illustrative embodiment of the present invention shown in FIG. 3, the system as described herein is part of a facility for producing oil and/or gas from a wellbore 301 which employs an electric submersible pump (ESP) 303 suspended within the wellbore 301 for artificial lift. A surface-located ESP control module 305 interfaces to an external power source and controls the supply of electrical power to the ESP 303 via power cables 307 therebetween. The ESP control module 305 is capable of selectively turning ON and shutting OFF the supply of power to the ESP. It may also incorporate variable-speed drive functionality that adjusts pump output by varying the operational motor speed of the ESP. The ESP control module 305 may also include functionality for real-time measurement of various operating parameters of the ESP (power supply voltage, amperage) and functionality for the calculation of indicators from measurements (current unbalance, over-voltage).

The ESP 303 also includes or interfaces to sensors that provide real-time measurement of various downhole operating parameters such as localized vibrations, localized fluid pressure, localized temperature and motor current leakage. The ESP 303 also includes downhole communication equipment for telemetry of the measured downhole parameters to a surface-located data acquisition module 309. For example, telemetry between the ESP 303 and the surface-located data acquisition module 309 is accomplished by communication of modulated signals over the power supply cables 307. Alternatively such telemetry can be accomplished by a wireless radio frequency data communication link therebetween or any other form of data communication, including communication links employing wires or fiber optic cables.

The ESP control module 305 as well as the data acquisition module 309 interface to an embedded device 312 typically referred to as a remote terminal unit (RTU). The RTU 312 is interfaced to an intermediate device 322. The intermediate device 322 provides two-way packet-based data communication to a remote management station 314 over a data communication network 316. The data communication network 316 preferably includes a satellite communication network, although other types of data communication networks can be used.

The intermediate device 322 provides packet forwarding to support normal packet-based communication between the remote management station 314 and the RTU 312. The RTU 312 provides for data Logging of the operating data and sensor data provided by the ESP control module 305 and the data acquisition module 309 remote monitoring of such data at the remote management station 314, and remote control of the ESP 303 at the remote management station 314 (e.g., turning the ESP 303 on and off and possibly adjusting pump output by varying the operational motor speed of the ESP 303 by signals supplied by the RTU 312 to the ESP control module 305).

The RTU 312 the intermediate device 322, and the remote management station 314 also support remote software upgrade of the RTU 312. Such remote software upgrade is logically partitioned into two phases as described above: a remote data transfer and verification phase (Phase 1) and a local upgrade phase (Phase 2). The Phase 1 operations transfer software upgrade data from the remote management station 314 to the intermediate device 322 and verify the software upgrade data received by the intermediate device 322. The Phase 2 operations transfer the software upgrade data from the intermediate device 322 to the RTU 312 and carry out the software upgrade process on the RTU 312. This software upgrade process loads the software upgrade data onto the RTU 312 in order to upgrade the software of the RTU 312. As part of the Phase 2 operations a backup copy of the software of the RTU 312 that is to be overwritten can transferred from the RTU 312 to the intermediate device 322 and can be returned back to the RTU 3 12 in the event that the software upgrade process fails. Exemplary operations for carrying out this multi-phase remote software upgrade process are described above in detail.

There have been described and illustrated herein several embodiments of a system and method for remote software upgrade of an embedded device. While particular embodiments of the invention have been described, it is not intended that the invention be limited thereto, as it is intended that the invention be as broad in scope as the art will allow and that the specification be read likewise. Thus, while particular applications of the invention have been disclosed with respect to a hydrocarbon producing facility that employs a remotely controlled electric submersible pump, it will be appreciated that the invention can be used in other applications as well. In addition, while particular types of networking topologies and methodologies, data transfer methodologies, software upgrade methodologies, and data processing methodologies have been disclosed, it will be understood that other such methodologies can be used. Moreover, while particular configurations have been disclosed in reference to the system components described herein, it will he appreciated that other configurations could be used as well. It will therefore be appreciated by those skilled in the art that yet other modifications could be made to the present invention without deviating from its scope as claimed.

What is claimed is:

1. A method for upgrading the software of an embedded device supporting packet-based communication the method comprising:
providing a packet-based communication path between a remote device and the embedded device;
placing an intermediate device in the packet-based communication path as a local node directly coupled to the embedded device, the intermediate device located locally with respect to the embedded device, and the intermediate device including packet forwarding means for carrying out normal communication between the remote device and the embedded device; and
upgrading the software of the embedded device by i) transferring software upgrade data from the remote device to the intermediate device, ii) transferring the software upgrade data from the intermediate device to the embedded device, and iii) carrying out an upgrade process on the embedded device that loads the software upgrade data on the embedded device.

2. A method according to claim 1, further comprising:
on the intermediate device, verifying the software upgrade data on a per-packet basis during transfer from the remote device.

3. A method according to claim 2, further comprising:
communicating between the intermediate device and the remote device to resend any packet of the software upgrade data that fails verification.

4. A method according to claim 1, further comprising:
on the intermediate device, reassembling the software upgrade data after transfer from the remote device and performing verification of the reassembled software upgrade data.

5. A method according to claim 4, further comprising:
communicating between the intermediate device and the remote device to resend the software upgrade data in the event that the verification of the reassembled software upgrade data fails.

6. A method according to claim 1, wherein the embedded device stores operating parameters and settings therein, and further comprising:
on the intermediate device, making a copy of the operating parameters and settings and storing the copy during the upgrading.

7. A method according to claim 6, further comprising:
communicating between the intermediate device and the embedded device to transfer the copy of the operating parameters and settings to the embedded device.

8. A method according to claim 1, further comprising:
on the embedded device, making a backup copy of the software of the embedded device and transferring the backup copy to the intermediate device.

9. A method according to claim 8, wherein:
the operation of the embedded device, in making the backup copy and transferring the backup copy to the intermediate device is initiated by a request communicated from the remote device to the intermediate device.

10. A method according to claim 9, wherein:
the request is communicated from the remote device to the intermediate device before ii).

11. A method according to claim 1, further comprising:
on the embedded device verifying the software upgrade data on a per packet basis during transfer from the intermediate device.

12. A method according to claim 11, further comprising:
communicating between the embedded device and the intermediate device to resend any packet of the software upgrade data that fails verification.

13. A method according to claim 1, further comprising:
on the embedded device reassembling the software upgrade data after transfer from the intermediate device and performing verification of the reassembled software upgrade data.

14. A method according to claim 13, further comprising communicating, between the embedded device and the intermediate device to resend the software upgrade data in the event that the verification of the reassembled software upgrade data fails.

15. A method according to claim 1, further comprising:
on the embedded device verifying the upgrade process carried out on the embedded device.

16. A method according to claim 15, further comprising:
in the event that the verification of the upgrade process carried out on the embedded device fails, repeating the upgrade process and subsequent verification on the embedded device.

17. A method according to claim 8, further comprising:
communicating between the embedded device and the intermediate device to transfer the backup copy to the embedded device; and
carrying, out a restore process that loads the backup copy on the embedded device.

18. A method according to claim 17, wherein:
the operation of the embedded device in communicating with the intermediate device to transfer the backup copy to the embedded device and carry out the restore process is initiated when verification of the upgrade process on the embedded device fails.

19. A method according to claim 1, further comprising:
communicating from the embedded device to the intermediate device a status message indicating the outcome of the upgrade process; and
forwarding the status message from the intermediate device to the remote device.

20. A method according to claim 1, further comprising:
while upgrading the software of the embedded device, controlling the packet forwarding means of the intermediate device to suspend normal communication between the remote device and the embedded device.

21. A method according to claim 20, wherein:
before ii), the packet forwarding means is controlled to suspend normal communication between the remote device and the embedded device.

22. A method according to claim 1, wherein:
the embedded device comprises an apparatus for remote control of an electric submersible pump suspended within a wellbore for artificial lift of hydrocarbons produced therein.

23. A system for upgrading the software of an embedded device supporting packet-based communication, the system comprising:
a remote device;
a packet based communication path between the remote device and the embedded device: and
an intermediate device disposed in said packet based communication path as a local node directly coupled to the embedded device, said intermediate device located locally with respect to the embedded device, and said intermediate device including packet forwarding means for carrying out normal communication between the remote device and the embedded device;
wherein said remote device and said intermediate device include means for transferring software upgrade data from the remote device to the intermediate device;
wherein said intermediate device and said remote device include means for transferring the software upgrade data from the intermediate device to the embedded device; and
wherein the embedded device includes means for carrying out an upgrade process that loads said software upgrade data on the embedded device.

24. A system according to claim 23, wherein:
said intermediate device verifies the software upgrade data on a per-packet basis during transfer from the remote device.

25. A system according to claim 24, wherein:
said intermediate device communicates with said remote device to resend any packet of the software upgrade data that fails verification.

26. A system according to claim 23, wherein:
said intermediate device reassembles the software upgrade data after transfer from the remote device and performs verification of the reassembled software upgrade data.

27. A system according to claim 26, wherein:
said intermediate device communicates with said remote device to resend the software upgrade data in the event that the verification of the reassembled software upgrade data fails.

28. A system according to claim 23, wherein:
said embedded device stores operating parameters and settings therein, and wherein said intermediate device makes a copy of the operating parameters and settings and stores the copy during the upgrade process.

29. A system according to claim 23, wherein:
said embedded device makes a backup copy of the software of the embedded device and transfers the backup copy to the intermediate device.

30. A system according to claim 29, wherein:
the operation of said embedded device in making the backup copy and transferring the backup copy to said intermediate device is initiated by a request communicated from said remote device to said intermediate device.

31. A system according to claim 30, wherein:
said request is communicated from said remote device to said intermediate device before the software upgrade data is transferred from the intermediate device to the embedded device.

32. A system according to claim 23, wherein:
said embedded device verifies the software upgrade data on a per-packet basis during transfer from said intermediate device.

33. A system according to claim 32, wherein:
said embedded device communicates with said intermediate device to resend any packet of the software upgrade data that fails verification.

34. A system according to claim 23, wherein:
said embedded device reassembles the software upgrade data after transfer from said intermediate device and performs verification of the reassembled software upgrade data.

35. A system according to claim 34, wherein:
said embedded device communicates with said intermediate device to resend the software upgrade data in the event that the verification of the reassembled software upgrade data fails.

36. A system according to claim 23, wherein:
said embedded device verifies the upgrade process carried out on said embedded device.

37. A system according to claim 36, wherein:
said embedded device is adapted to repeat the upgrade process and subsequent verification in the event that the verification of the upgrade process carried out on said embedded device fails.

38. A system according to claim 29, wherein:
said embedded device communicates with said intermediate device to transfer the backup copy to said embedded device and carries out a restore process that loads the backup copy on said embedded device.

39. A system according to claim 38, wherein:
the operation of said embedded device in communicating with said intermediate device to transfer the backup copy to said embedded device and carry out the restore process is initiated when verification of the upgrade process on said embedded device fails.

40. A system according to claim 28, wherein:
said intermediate device transfers the copy of the operating parameters and settings to the embedded device.

41. A system according to claim 23, wherein:
said embedded device communicates to said intermediate device a status message indicating the outcome of the upgrade process, and said intermediate device forwards the status message to said remote device.

42. A system according to claim 23, wherein:
said packet forwarding means of the intermediate device suspends normal communication between said remote device and said embedded device while upgrading the software of the embedded device.

43. A system according to claim 42, wherein:
said packet forwarding means is adapted to suspend normal communication between said remote device and said embedded device before software upgrade data is transferred from the intermediate device to the embedded device.

44. A system according to claim 23, wherein:
the embedded device comprises an apparatus for remote control of an electric submersible pump suspended within a wellbore for artificial lift of hydrocarbons produced therein.

45. An apparatus for upgrading the software of an embedded device, the apparatus comprising:
a first network interface for packet-based communication with at least one remote device over a communication network:
a second network interface means for packet-based communication with the embedded device over a communication link therebetween;
packet forwarding means, operably disposed between the first and second network interfaces, for carrying out normal communication between the remote device and the embedded device; and
processing means for upgrading the software of the embedded device, said processing means adapted to i) communicate with the remote device to transfer software upgrade data from the remote device to the processing means and ii) communicate with the embedded device to transfer the software upgrade data from the processing means to the embedded device for loading onto the embedded device.

46. An apparatus according to claim 45, wherein:
the apparatus is located locally with respect to the embedded device and located remotely with respect to the remote device.

47. An apparatus according to claim 45, wherein:
said processing means verifies the software upgrade data on a per-packet basis during transfer from the remote device to the processing means, and said apparatus communicates with said remote device to resend any packet of the software upgrade data that fails verification.

48. An apparatus according to claim 45, wherein:
said processing means reassembles the software upgrade data after transfer from the remote device and performs verification of the reassembled software upgrade data.

49. An apparatus according to claim 48, further comprising:
means for communicating with said remote device to resend the software upgrade data in the event that the verification of the reassembled software upgrade data fails.

50. An apparatus according to claim 45, further comprising:
means for storing a backup copy of the software of the remote device as supplied by the embedded device.

51. An apparatus according to claim 50, further comprising;
means for transferring the backup copy to the embedded device upon receiving a request from the embedded device.

52. An apparatus according to claim 45, further comprising:
means for transferring and storing a copy of embedded device operating parameters and settings.

53. An apparatus according to claim 45, further comprising:
means for resending the software upgrade data to the embedded device upon receiving a request from the embedded device.

54. An apparatus according to claim 45, further comprising:
means for receiving from the embedded device a status message indicating the outcome of the upgrade process carried out on the embedded device, and means for forwarding the status message to said remote device.

55. An apparatus according to claim 45, wherein:
said packet forwarding means is adapted to suspend normal communication between said remote device and said embedded device before software upgrade data is transferred to the embedded device.
